(19) United States
(12) Patent Application Publication
(10) Pub. No.: US 2025/0264250 A1
(43) Pub. Date: Aug. 21, 2025

(54) HEAT EXCHANGER WITH THREE DIMENSIONAL REDIRECTIONAL REFLECTOR FOR ENHANCED SOLAR ENERGY CAPTURE

(71) Applicant: Exowatt, Inc., Miami, FL (US)

(72) Inventors: Pedro NEVES, Miami, FL (US); Ehsan ORDOUIE, Miami, FL (US)

(21) Appl. No.: 19/055,494

(22) Filed: Feb. 17, 2025

Related U.S. Application Data
(60) Provisional application No. 63/555,008, filed on Feb. 17, 2024.

(51) Int. Cl. F24S 23/74; F24S 20/20; F24S 23/30; F24S 23/70; F24S 80/00

(52) U.S. Cl. CPC F24S 23/74; F24S 20/20; F24S 23/30; F24S 2023/834; F24S 2080/011; F24S 2080/013

(57) ABSTRACT

A dual-plate heat exchanger, in combination with a parabolic trough, ensures efficient absorption of solar rays by redirecting any lost or scattered rays, enhancing overall system performance and energy yield. Another heat exchanger comprises a cylindrical quartz tube.

### CROSS-REFERENCES TO RELATED APPLICATIONS

This application claims benefit of U.S. Provisional Patent Application No. 63/555,008 filed Feb. 17, 2024, which is incorporated herein by reference in its entirety and for all purposes.

### STATEMENT REGARDING FEDERALLY SPONSORED RESEARCH OR DEVELOPMENT

None.

### FIELD

The technology herein relates to optimizing solar energy capture by mitigating issues related to tolerance, calibration, and scattered rays, and more particularly to a combination of a three dimensional mirror with a heat exchanger and solar Fresnel lens or panel. Embodiments provide a multidimensional heat exchanger, in combination with a parabolic or bathtub shaped trough, that ensures efficient absorption of solar rays by redirecting any lost or scattered rays, enhancing overall system performance and energy yield.

### BACKGROUND AND SUMMARY

Solar energy offers great potential in reducing dependence on fossil fuels and providing a clean energy source. There is therefore a need for solar collectors that have high or increased efficiency. Existing technology suffers from performance degradation relating to errors due to tolerances, mis (or no) calibration, and scattering of rays. Mechanical tracking of solar collectors with the sun's changing position can be useful but there are applications in which simplicity is desired.

### BRIEF DESCRIPTION OF THE DRAWINGS

These and other features and advantages will be better and more completely understood by referring to the following detailed description of exemplary non-limiting illustrative embodiments in conjunction with the drawings of which:

FIG. 1 shows a simplified drawing of an example embodiment using a dual surface heat exchanger/absorber.

FIG. 2 shows an example embodiment using a multidimensional (tubular) heat exchanger/absorber.

FIG. 3 shows a cross-section of the operation of the FIG. 2 embodiment.

FIG. 4 shows a cross-section of operation of a further embodiment using a bathtub shaped design.

FIGS. 5 and 6 show different views of a continuous tubular heat absorber.

### DETAILED DESCRIPTION OF EXAMPLE NON-LIMITING EMBODIMENTS

Example embodiments address the challenge of optimizing solar energy capture by mitigating issues related to tolerance, calibration, and scattered rays. A multi-dimensional heat absorber, in combination with a 3D reflecting surface, ensures efficient absorption of solar rays by redirecting any lost or scattered rays, enhancing overall system performance and energy yield.

One example embodiment provides a solar collector comprising a lens; a solar reflector; and an absorber that receives both thermal energy focussed directly thereon by the lens and thermal energy reflected by a 3D reflector that encloses the absorber.

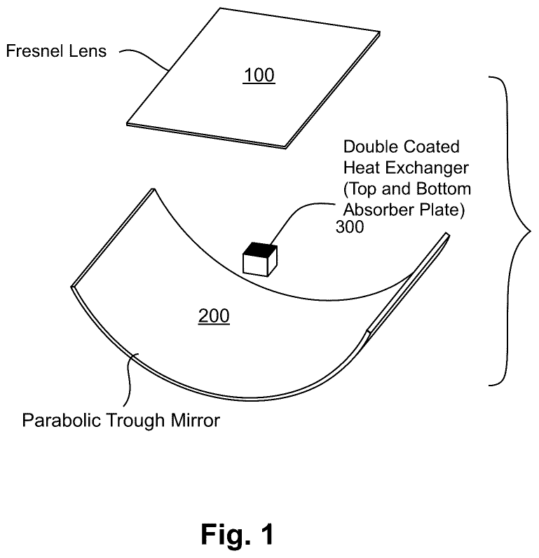

As shown in FIG. 1, a Solar Fresnel Lens 100 is employed to efficiently concentrate and focus solar rays onto a heat exchanger and absorber plate 300. To maximize capture and address potential issues arising from tolerance variations, calibration discrepancies, or scattered rays, a 3D reflector 200 is strategically positioned below the heat exchanger 300. This 3D reflector 200 acts as a secondary capture mechanism, ensuring that any solar radiation not precisely targeted by the Fresnel lens 100 onto the top absorber plate of heat exchanger 300 is redirected and utilized. The shape of the reflector can be any 3D shape such as a parabola, a hemisphere, a cube, an inverted pyramid, a triangular prism, an inverted cone, a cuboid, a hexagonal prism, or an irregular shape such as a “bathtub” shape in one embodiment.

In practice, support arrangements or mechanisms such as metal or other rigid frame members are used to support the Fresnel lens 100, reflector 200 and heat exchanger 300 relative to one another and relative to the sun's position. In some embodiments, an automatic tracking system can be used to automatically aim the Fresnel lens 200 and the 3D reflector 200 towards the sun as the sun moves in the sky. Other embodiments omit any tracking and provide fixed position Fresnel lenses that concentrate//focus the sun's rays coming in from a variety of different angles as the sun's position changes in the sky.

An example heat exchanger 300 features two coated absorber plates—one positioned at the top of the heat exchanger and the other at the bottom of the heat exchanger, specifically designed for interaction with the reflector 200. The top absorber plate receives thermal energy focussed onto it by the Fresnel lens 100. The bottom absorber plate receives thermal energy focussed onto it by the reflector 200. The reflector 200 also receives thermal energy from the Fresnel lens 100 that “misses” the top absorber plate, e.g., due to mis or no calibration of the Fresnel lens-top absorber path relative to the sun. This can happen due e.g., to tracking errors (in embodiments where the FIG. 1 arrangement tracks the sun's position in the sky) or in applications where there is no tracking (e.g., when seasonal changes of the sun's position causes the focal point of the Fresnel lens 100 to move off of the top absorber plate). This dual-plate heat exchanger 300 configuration thus enhances energy absorption and utilization, contributing to the overall efficiency and reliability of the solar thermal technology.

The heat exchanger 300 may be coupled to a heat circulation system (not shown) such as a stream of fluid or gas that moves heat from the heat exchanger to a thermal load and/or thermal storage.

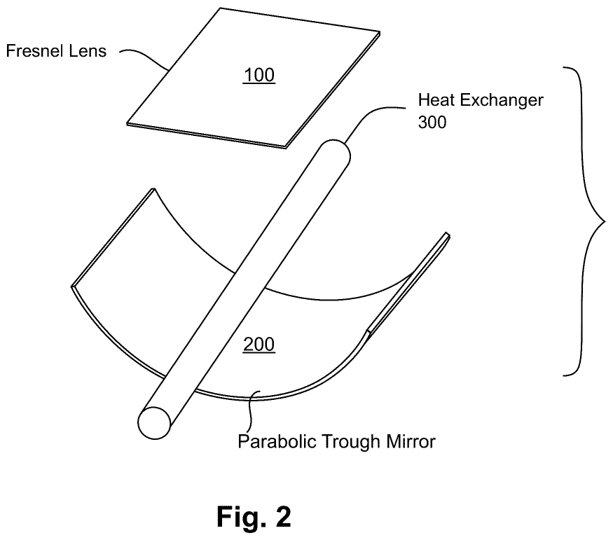

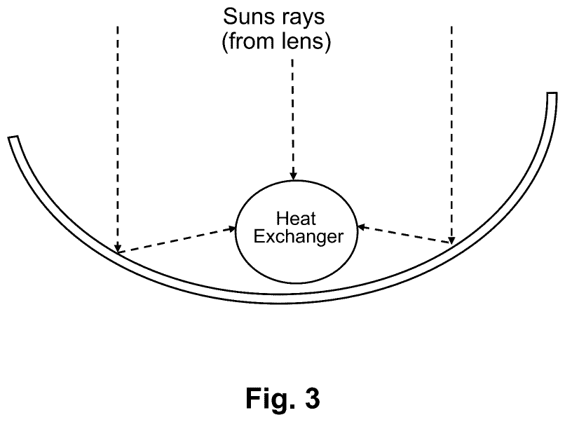

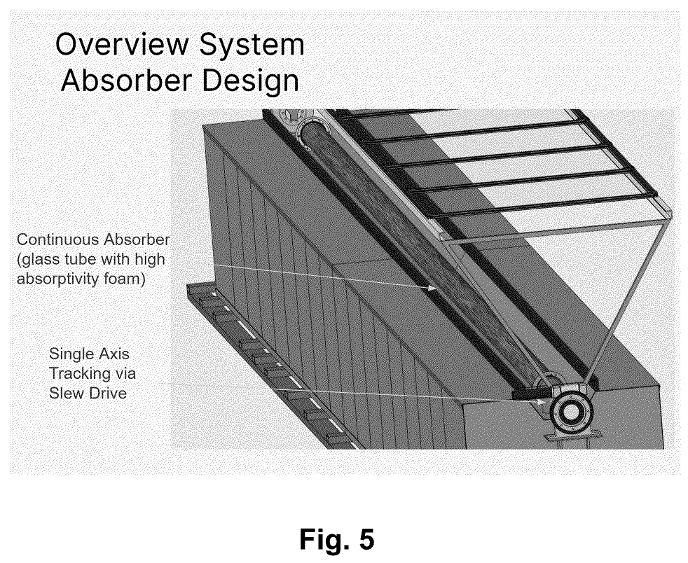

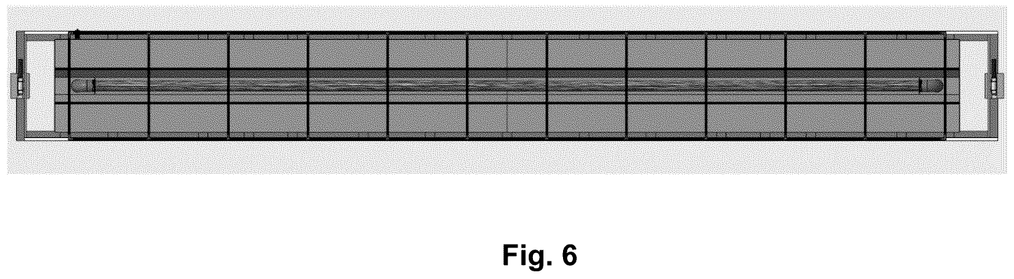

FIG. 2 shows a further embodiment wherein the heat exchanger comprises a tubular structure that is able to receive thermal energy from any angle. The continuous absorber which in this embodiment can comprise a glass or quartz tube containing e.g., foam with high thermal absorption. The continuous absorber in one embodiment comprises a hollow tubular structure or pipe comprising high-temperature glass, quartz or other radiation transparent material that efficiently admits heat. The tube-shaped design provides more surface area (high absorptivity and high porosity), allowing it to absorb light more effectively at different angles due to its curved geometry. Inside the radiation-transmissive pipe is high absorption e.g., stainless steel foam or other material that absorbs the thermal energy. See FIGS. 5 and 6 showing different views of the tubular heat absorber (in this embodiment a Fresnel lens array is tracked in one axis on a movable frame, but other embodiments may use different lens arrangements). The radiation-transmissive pipe retains the thermal energy within the absorber structure. A flow of thermal transport fluid such as air or other gas moves the thermal energy along the linear absorber and transports it to a thermal storage or other thermal load in one embodiment. As shown in FIG. 3, the reflective walls of the reflector help to reflect back the light that does not initially impinge on the tube absorber. The absorber is positioned within or partially within the 3D reflector enclosure in one embodiment such that the reflector surrounds the heat exchanger to maximize reflection towards the heat exchanger from a variety of light angles and to physically protect the heat exchanger from the elements.

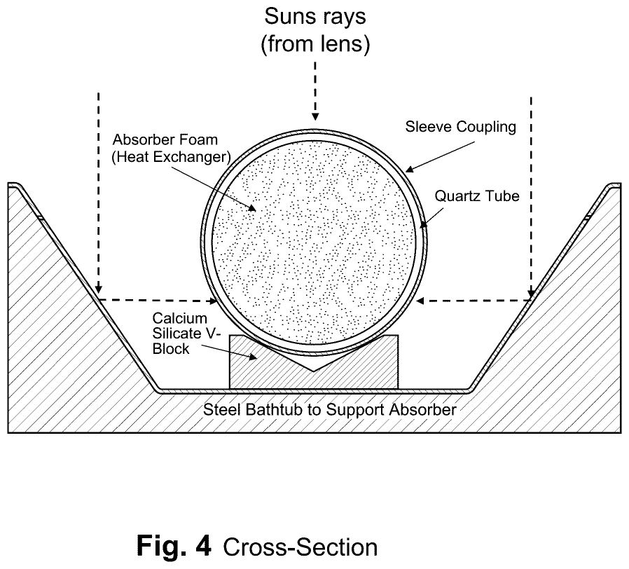

FIG. 4 shows another embodiment wherein the shape of the 3D reflector in cross-section resembles a bathtub with a flat bottom and sloped sides. As shown, light is reflected from the sloped sides toward a tubular heat exchanger shown here in cross-section. the tubular heat exchanger in one embodiment comprises cylindrical transparent quartz tube that rests on a calcium silicate block. The calcium silicate block has an upper surface that defines a “v” groove therein. The v-groove supports the quartz tube in a way that ensures the quartz tube does not crack. The quartz tube contains absorber foam that absorbs heat. A sleeve coupling is used to thermally couple heat absorbed by the absorber foam to a thermal storage or thermal load.

The quartz tube's outer surface defines a first arcuate surface portion that faces generally upwards in the diagram. this first arcuate surface portion directly receives radiation concentrated by one or more lenses such as fresnel lens panels. The quartz tube's outer surface further defines second and third arcuate surface portions that face laterally or generally downwards (e.g., from 7 o'clock to 11 o'clock, and from 1 o'clock to 5 o'clock, respectively). The second and third arcuate surface portions receive radiation reflected by the bathtub reflector. The quartz tube's cylindrical shape is thus efficient in receiving radiant energy from a reflector structure disposed beneath a fresnel lens panel. the quartz tube's transparency allows the received radiant energy to pass through the quartz tube's cylindrical walls into the interior of the quartz tube, where absorber foam is disposed. This absorber foam may comprise very high temperature material that absorbs heat. The foam defines a plethora of micropassages that permits air or other fluid to flow therethrough. The air is retained within the quart tube because the quart tube's walls are not air permable. The air thus flows longitdinally through the quartz tube, picking up heat as it flows. A blower can be used to force air to flow through the quartz tube at a desired flow rate. As the air flows through the tube, it picks up heat from the absorber foam and carries the heat to a destination such as a thermal storage, stirling engine, or other thermal load. The blower can recirculate the still-heated air back through the tube so it can pick up more heat again and deliver the heat to the thermal load.

FIGS. 5 and 6 show that different portions of the quartz tube may be disposed beneath different Fresnel lens panels. The quartz tube thus comprises a continous absorber that heats air carried therein by a first ΔT in response to solar energy focussed by a first fresnel lens panel; heats that same already-heated air carried therein by a second ΔT in response to solar energy focussed by a second fresnel lens panel; and so on to heat that same already-heated air carried therein by an nth ΔT in response to solar energy focussed by an nth fresnel lens panel, where the panels are arranged in a linear array (in one embodiment) to successively heat the air within the tube as it travels down the linear array of lens panels.

FIG. 5 shows a single axis tracking system that tracks the sun with the linear array to thereby keep the focussed rays of the sun impinging on the quartz tube. For more detail, see e.g., U.S. patent application No. 63/692,663 filed Sep. 9, 2024 entitled “Multi-Drive Fresnel Lens Trackers for Sequential Heat Collection.”

While the technology herein has been described in connection with exemplary illustrative non-limiting embodiments, the invention is not to be limited by the disclosure. The invention is intended to be defined by the claims and to cover all corresponding and equivalent arrangements whether or not specifically disclosed herein.

We claim:

1. A solar collector comprising:
a lens;
a solar reflector;
a first absorber surface that receives thermal energy focussed thereon by the lens; and
a second absorber surface that receives thermal energy reflected by the solar reflector,
wherein the first and second absorber surfaces have different orientations.

2. The solar collector of claim 1 wherein the solar reflector is shaped as a trough.

3. The solar collector of claim 1 wherein the solar reflector is shaped as a bathtub.

4. The solar reflector of claim 1 wherein the first and second absorber surfaces comprise different surfaces of a three-dimensional absorber.

5. The solar collector of claim 1 wherein the first absorber surface and second absorber surface comprise first and second arcuate surfaces disposed on the outer cylindrical surface of a quartz tube.

6. The solar collector of claim 5 wherein the quartz tube contains absorber foam configured to transfer heat to a fluid flowing through the quartz tube.

7. The solar collector of claim 6 wherein the fluid comprises air.

8. The solar collector of claim 5 wherein the first actuate surface face the lens and the second arcuate surface faces the solar reflector.
